(19) United States
(12) Patent Application Publication
(10) Pub. No.: US 2019/0170124 A1
(43) Pub. Date: Jun. 6, 2019

(54) MEASUREMENT ARRANGEMENT FOR A WIND TURBINE

(71) Applicant: Wobben Properties GmbH, Aurich (DE)

(72) Inventors: Paul HAVLICEK, Aurich (DE); Heiko BAUMGART, Aurich (DE); Oliver BINDER, Aurich (DE)

(21) Appl. No.: 16/325,149

(22) PCT Filed: Aug. 9, 2017
(86) PCT No.: PCT/EP2017/070181

§ 371 Date: Feb. 12, 2019

(30) Foreign Application Priority Data
Aug. 18, 2016 (DE) 10 2016 215 533.4

(51) Int. Cl. F03D 17/00; F03D 7/02; F03D 7/04; G01M 5/00

(52) U.S. Cl. CPC F03D 17/00; F03D 7/028; F03D 1/00; G01M 5/0041; G01M 5/0025; F03D 7/048

(57) ABSTRACT

A measuring arrangement for a wind power installation for determining a thrust force of the rotor. A measuring device detects a first bending moment of the tower at a first height and a second bending moment of the tower at a second height, which is different from the first height. The first and second bending moments are in this case made up in each case of a natural moment component, a pitching moment component and a thrust force component. A thrust force determining unit determines a thrust force of the rotor based on a comparison of the at least first and second bending moments, so that the natural moment component and the pitching moment component cancel one another out.

### BACKGROUND

### Technical Field

The present invention relates to a measuring arrangement of a wind power installation for determining a thrust force of a rotor, to a wind power installation with the measuring arrangement, to a method for determining a thrust force of the rotor and to a method for operating a wind power installation. The present invention also comprises a wind farm and a method for operating a wind farm.

### Description of the Related Art

Wind power installations, which generate electrical energy from the kinetic energy of the wind and feed it into an electrical power supply grid, are generally known. Nowadays, such wind power installations are usually operated in the form of wind farms, that is to say collections of wind power installations in a confined area.

During the planning and operation of such wind farms, it must be taken into account how the individual wind power installations of the wind farm influence one another. In particular in the wake, that is to say downstream of the rotor of a wind power installation, strong turbulences can form. A wind power installation that is located precisely in these turbulences of an upstream wind power installation may be influenced by these turbulences to such an extent that the energy yield is reduced or even that the wind power installation is damaged.

For this reason, during the planning of a wind farm, the turbulences in the wake of each individual wind power installation are included as a limiting factor in setting the distance between the individual wind power installations. With the aid of simulations, the turbulences downstream of the individual wind power installations are simulated for different wind directions, and then the minimum distance between the wind power installations is determined while taking into account the prevailing wind direction at a specific location and while adding a safety margin. In this case, for safety reasons the distances between the wind power installations must be chosen to be greater than would be necessary most of the time in the operation of the wind farm. This has the consequence that significantly fewer wind power installations per surface area can be set up and the wind farm, for which usually only a limited area is available, is greatly restricted in its output. Another issue is that, in the case of extreme events or for example when the wind is not coming as intended from the prevailing wind direction, problems with turbulences in the wake of wind power installations can nevertheless occur.

### BRIEF SUMMARY

Provided are measuring arrangements and methods of determining turbulences in the wake of a wind power installation to be simplified, and consequently the control of wind farms to be improved.

Provided is a measuring arrangement of a wind power installation having a tower and an aerodynamic rotor with at least one rotor blade for determining a thrust force of the rotor, comprising:
a measuring device for detecting a first bending moment of the tower at a first height and a second bending moment of the tower at a second height, which is different from the first height, the first and second bending moments being made up in each case of a natural moment component, a pitching moment component and a thrust force moment component; and
a thrust force determining unit or processor for determining a thrust force based on a first comparison value, determined on the basis of a comparison of the at least first and second bending moments, the first comparison value being independent of the natural moment component and the pitching moment component.

The fact that the measuring device detects a first and a second bending moment of the tower of the wind power installation at different heights, the first and second bending moments being made up in each case of a natural moment component, a pitching moment component and a thrust force component, has the effect of making it possible for the thrust force determining unit to determine a thrust force based on a first comparison value between the first and second bending moments, the first comparison value being independent of the natural moment component and the pitching moment component. Preferably, the contributions of the natural moment component and the pitching moment component in the comparison value therefore balance one another or cancel one another out. Since it is known that the thrust force of a rotor correlates directly with the turbulences in the wake, the thrust force offers a direct parameter for assessing the turbulence produced by a wind power installation. By determining the thrust force in real time by the thrust force determining unit during the operation of the wind power installation, the turbulence in the wake that is produced by the wind power installation can consequently be determined for each point in time, so that it is made possible to control the wind power installation in such a way that the turbulence at each point in time is limited.

The natural moment component occurs because the center of gravity of the nacelle does not lie in line with the vertical center axis of the tower, that is to say there is a horizontal distance greater than zero between the center of gravity of the nacelle and the center axis of the tower. The natural moment component is dependent on the force of the weight acting on the nacelle and the distance between the center of gravity of the nacelle and the center axis of the tower. The natural moment component acts constantly over the entire height of the tower.

The pitching moment component occurs due to the compressive forces of the wind acting at different heights on the rotor blades. This inequality causes a torque, which acts also the rotor and is transferred via the rotor to the tower. The pitching moment component also acts constantly over the height of the tower. The thrust force moment component is produced by the thrust force acting on the rotor and is dependent on the height of the tower of the wind power installation.

It is also proposed that the measuring device has a first sensor for detecting the first bending moment of the tower at the first height and a second sensor for detecting the second bending moment of the tower at the second height, which is different from the first height.

Since the measuring device is designed in such a way as to have a first and a second sensor respectively at the first and second heights, the bending moment can be measured at the respective height directly on the tower. This significantly improves the accuracy of the measurement, and consequently also the accuracy of the determination of the thrust force from the measured values.

It is also proposed that the first sensor is arranged directly under the nacelle of the wind power installation and the second sensor is arranged in the vicinity of a foot of the wind power installation.

The fact that the first sensor is arranged directly under a nacelle of the wind power installation and the second sensor is arranged in the vicinity of the foot of the wind power installation means that a maximum distance, and consequently a maximum difference in height, between the two sensors is achieved. The greater the distance between the sensors on the tower, the greater also the difference between the measured first bending moment and the measured second bending moment, so that the first comparison value can be determined particularly accurately from the comparison of the first and second bending moments. As a result, the accuracy of the determination of the thrust force can likewise be increased. Directly means in this context that the sensors are provided as close as possible to the nacelle, or the foot, in particular at a distance of less than 1 m to 5 m.

It is also proposed that the sensors have strain gauges, in particular full strain gauge bridges. Strain gauges, in particular full strain gauge bridges, are particularly suitable for determining the bending moment of the tower of a wind power installation in an effective and cost-saving manner.

It is also proposed that the thrust force determining unit determines as the first comparison value a difference between the first and second bending moments.

The fact that the first comparison value is determined as a difference between the first and second bending moments means that it is ensured that the natural moment component and the pitching moment component in the first comparison value cancel one another out and all that remains in the first comparison value are the elements of the thrust force component. Consequently, the first comparison value is indicative of the thrust force component of the wind power installation.

It is also proposed that the thrust force determining unit determines a thrust force of the rotor based on the first comparison value and the difference in height between the first and second heights, in particular as a ratio of the first comparison value and the difference in height.

By determining the ratio of the first comparison value and a difference in height between the first and second heights at which the first and second bending moments are determined, the thrust force of the rotor can be determined directly.

It is also proposed that the measuring device has at least a third sensor for detecting a third bending moment of the tower at a third height, the third height lying between the first and second heights, in particular midway.

The fact that the measuring device has a third sensor for detecting a third bending moment at a third height between the first and second heights means that it can be ensured that, if there is a failure of one of the sensors at the first and second heights, the determination of a thrust force of the rotor is possible. This increases safety when operating the wind power installation and makes it possible for the wind power installation to continue in operation even when there is a failure of one of the sensors.

It is also proposed that the thrust force determining unit is designed for determining a first thrust force based on the first comparison value on a difference in height between the first and second heights, a second thrust force based on the second comparison value and a difference in height between the first and third heights, and a third thrust force based on the third comparison value and a difference in height between the third and second heights.

The fact that a second comparison value and a third comparison value is respectively formed from a difference between the first and third bending moments and a difference between the third and second bending moments has the effect of making it possible to determine the accuracy in the determination of the bending moment by comparison of the first, second and third comparison values. Thus, for example, the second and third comparison values should as far as possible be the same if the third sensor is arranged midway between the first and second sensors. If deviations above a certain tolerance limit are determined in the predetermined relationships, this indicates that at least one of the sensors involved has provided an incorrect measurement and, if the result does not improve when the measurement is repeated, the sensor possibly has a malfunction. It can in this way be detected in good time if one of the sensors has a malfunction, and the malfunction can be reported to an operator of the wind power installation.

It is also proposed that the thrust force determining unit is designed for determining at least a second and a third comparison value, the second comparison value being formed as a difference between the first and third bending moments and the third comparison value being formed as a difference between the third and second bending moments.

The fact that first, second and third thrust forces are preferably determined by being based on the first, second and third comparison values and the respective differences in height has the effect of making it possible to compare the thrust forces determined. In this case, all three thrust forces should lie in a predefined similar range if there is no malfunction or incorrect measurement of the sensors. Furthermore, the three thrust forces can be used for increasing the accuracy of the thrust force measurement, in particular for forming a mean value of the first to third thrust forces.

It is also proposed that the thrust force determining unit is designed for determining the thrust force of the rotor as a mean value of at least two of the first, second and third thrust forces, or the thrust force determining unit is designed for determining the thrust force of the rotor as a weighted combination of the first, second and third thrust forces, weights of the combination being based on a measure of the accuracy of the first, second and third thrust forces.

The fact that the thrust force of the rotor is determined from a weighted combination of the first, second and third thrust forces, the weights of the combination being based on a measure of the accuracy of the first, second and third thrust forces, means that the accuracy of the thrust force determined of the rotor can be increased further. In particular, the value of a thrust force is more accurate the greater the difference in height between the sensors is, that is to say the weights for the combination of the first to third thrust forces may be chosen in particular in a manner dependent on the difference in height of the sensors involved in each case. Furthermore, the weights may also include knowledge of the measuring accuracy of the respective sensors. This makes it possible to determine the thrust force of the rotor with great accuracy.

Also proposed is a wind power installation with a measuring arrangement as described above, the wind power installation being designed for being operated in dependence on the thrust force determined.

Also proposed is a wind farm for generating electricity, the wind farm having:
at least one wind power installation with a measuring arrangement as described above;
a turbulence determining unit or processor for determining the turbulence of at least one wind power installation based on the thrust force of the rotor of the wind power installation, and
a wind farm control unit or controller for controlling the at least one wind power installation of the wind farm, in particular for reducing the output of the at least one wind power installation of the wind farm, so that the effects of the turbulence of the at least one wind power installation on other wind power installations of the wind farm is reduced.

The fact that the wind farm control unit controls the output of the wind power installations of the wind farm based on the thrust force determined of the rotor of each wind power installation in such a way that the effects of the turbulence in the wake of the wind power installations is reduced has the effect of making it possible to integrate a greater number of wind power installations per unit area into the wind farm, so that the overall output of the wind farm per unit area can be increased without reducing the safety for the operation of the wind power installation. By contrast, the safety during operation of the wind farm is increased by the fact that the value of the turbulence in the wake of each wind power installation can be individually controlled even in situations that are unforeseen by the simulation.

Also proposed according to the invention is a method for determining a thrust force of a rotor wind power installation having a tower and an aerodynamic rotor with at least one rotor blade, the method comprising:
detecting a first bending moment of the tower at a first height and a second bending moment of the tower at a second height, which is different from the first height, the first and second bending moments being made up in each case of a natural moment component, a pitching moment component and a thrust force moment component; and
determining a thrust force based on a first comparison value determined on the basis of a comparison of the at least first and second bending moments, the first comparison value being independent of the natural moment component and the pitching moment component.

It is proposed to operate the method as provided by the explanations of at least one of the foregoing embodiments of the measuring arrangement.

Also proposed is a method for operating a wind power installation, the wind power installation having a measuring arrangement according to one of the embodiments explained above and the wind power installation being operated in dependence on the thrust force determined.

Also proposed is a method for operating a wind farm, the method having the steps of:
determining the turbulence of at least one wind power installation based on the thrust force of the rotor of the wind power installation; and
controlling the wind power installations of the wind farm, in particular reducing the output of the at least one wind power installation of the wind farm, so that the effects of the turbulence of the at least one wind power installation on other wind power installations of the wind farm is reduced.

It should be understood that the measuring arrangement as claimed in claim 1, the wind power installation as claimed in claim 11, the wind farm as claimed in claim 12 and the methods as claimed in claim 13, 14 or 15 have similar and/or identical preferred embodiments, as they are defined in particular in the dependent claims.

### BRIEF DESCRIPTION OF THE SEVERAL VIEWS OF THE DRAWINGS

The present invention is now explained in more detail below by way of example on the basis of exemplary embodiments with reference to the accompanying figures.

FIG. 1 shows a schematic view of a wind power installation having a measuring arrangement.

FIG. 2 shows a schematic view of the composition of bending moments acting on a wind power installation.

### DETAILED DESCRIPTION

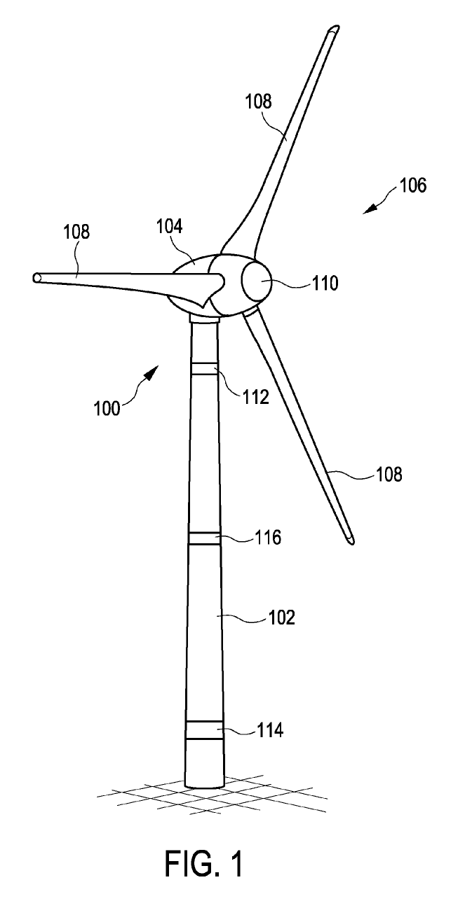

FIG. 1 shows a wind power installation 100 with a tower 102 and a nacelle 104. Arranged on the nacelle 104 is an aerodynamic rotor 106 with rotor blades 108 and a spinner 110. During operation, the rotor 106 is set in a rotational motion by the wind and thereby drives a generator in the nacelle 104.

Also arranged on the tower 102 of the wind power installation 100 is a measuring device, the measuring device having a first sensor 112, a second sensor 114 and a third sensor 116. The first, second and third sensors 112, 114, 116 are designed in each case for determining the bending moment of the tower 102 of the wind power installation 100 at the respective height.

In this exemplary embodiment, the first, second and third sensors 112, 114, 116 are formed by in each case by at least two full strain gauge bridges. In this case, the full strain gauge bridges are configured in such a way that a measuring grid foil with a thin resistance wire is applied to the surface of the tower 102, it being possible by means of a Wheatstone bridge circuit, in particular in the embodiment of a full bridge, for changes in the length of the resistance wire to be measured as changes in the resistance of the resistance wire. Such strain measuring sensors make it possible even to determine very small changes, in particular bends, of the carrier, that is to say here the tower 102 of the wind power installation 100, with great accuracy.

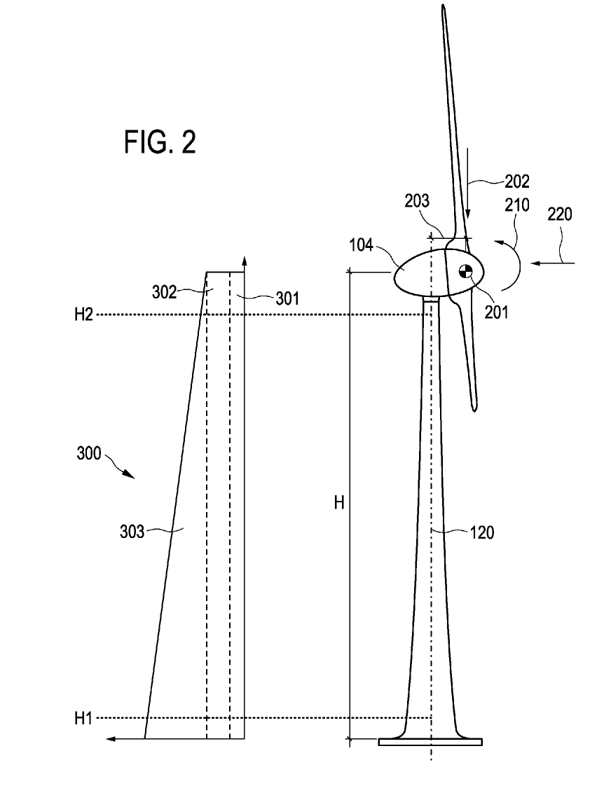

FIG. 2 schematically shows which components make up a determined bending moment of the tower 102 of the wind power installation 100. The mass of the nacelle 104 produces a force of weight 202, which acts on the center of gravity 201 of the nacelle 104. Since the weight of the rotor blades 108 shifts the center of gravity in the direction of the rotor 106, the center of gravity 201 of the nacelle 104 generally lies outside a vertical center axis 120 of the tower 102 in the horizontal direction. As a result, the mass of the nacelle 104 causes a natural moment on the tower 102 of the wind power installation 100. This natural moment is determined from the force of weight 102 that acts on the nacelle 104, and the distance 203 between the center of gravity 201 of the nacelle 104 and the center axis 120 of the tower 102. The following formula is obtained for the natural moment:

Mₙₐₜ=Fg×I₂,

where Mₙₐₜ is the natural moment of the nacelle 104, Fg is the force of weight 202 that acts on the nacelle 104 and I₂ is the distance 203 between the center of gravity 201 of the nacelle 104 and the center axis 120 of the tower 102. It should be taken into account that the natural moment of the nacelle 104 acts constantly over the entire height H of the tower 102.

A pitching moment 210 also acts on the tower 102 of the wind power installation 100. The pitching moment 210 is caused by the different wind speeds in the rotor area that is flowed through. Thus, the wind speed generally increases from the bottom upward over the described rotor area, that is to say that a rotor blade 108 that is located above the nacelle 104 is exposed to a higher wind speed than a rotor blade 108 that is under the nacelle 104. The forces occurring as a result on the rotor blades 108 produce a pitching moment 210, the loading of the pitching moment 210 likewise remaining the same over the entire height H of the tower 102.

A thrust force 220 also acts on the rotor 106 in the direction of the wind, the thrust force 220 being applied directly at the center of gravity 201 of the rotor 106. This has the consequence that the thrust force 220 exerts a bending moment via the tower 102 as a lever on the tower 102. In particular, the bending moment of the thrust force 220 is dependent on the height H of the tower 102 and thereby obeys the law:

Mₜₕᵣᵤₛₜ=Fₜₕᵣᵤₛₜ×H,

where Fₜₕᵣᵤₛₜ is the thrust force 220, Mₜₕᵣᵤₛₜ is the bending moment based on the thrust force 220 and H is the height of the tower 102 of the wind power installation 100.

The diagram 300 schematically shows once again the value of the bending moment with the height of the wind power installation 100. In this case, the bending moment is plotted on the x axis and the height of the wind power installation is plotted on the y axis. It can be seen from the schematic progression of the bending moment that the bending moment at each height is made up of three moment components, to be specific the natural moment component 301, the pitching moment component 302 and the thrust force moment component 303. Since, as explained above, the natural moment component 301 and the pitching moment component 302 are constant over the height H of the tower 102, only the thrust force moment component 303 exhibits a progression, which is dependent on the height H of the tower 102, in particular proportional to the height H of the tower 102. It follows from this that, when a bending moment at the height H2 is subtracted from a bending moment at the height H1, the natural moment component 301 and the pitching moment component 302, which are constant over the height, and consequently equal in both bending moments, cancel one another out. What remains is an element of the thrust force moment component 303.

Since the thrust force moment component 303 is directly proportional to the height H of the tower 102, it is generally possible by means of the formula:

Fₜₕᵣᵤₛₜ=(B1−B2)/(H1−H2)

to calculate the thrust force 2201 that acts on the rotor 106, where B1 is a first bending moment, B2 is a second bending moment and H1 is a first height and H2 is a second height of the respective bending moment.

Based on the above findings concerning the composition of the bending moments that act on the tower 102 of the wind power installation 100, it is therefore possible by means of measuring the bending moments at least two heights H1, H2 to determine the thrust force 220 that acts on the rotor 106.

In the embodiment shown here, the bending moment is determined by means of the first sensor 112, the second sensor 114 and the third sensor 116 respectively at a first height H1, a second height H2 and a third height H3. It is consequently possible by

V1=B2−B1

to determine a first comparison value V1, where V1 is the first comparison value, B1 is the bending moment, which is measured by the first sensor 112, and B2 is the second bending moment, which is measured by the second sensor 114. Furthermore, it is possible by

V2=B3−B1,

V3=B2−B3,

to determine a second and a third comparison value, where V2 is the second comparison value, V3 is the third comparison value and B3 is the bending moment, which is measured by the third sensor 116.

As emerges from the schematic representation 300 and has been explained above, all three comparison values only contain elements of the thrust force moment component 303. It can likewise be seen from the schematic representation 300 that the thrust force component 303 decreases constantly with the height. It follows from this that, with correct measurement of the bending moment, the second and third bending moments are equal, so it should therefore be that V2=V3. Since, in this exemplary embodiment, the third sensor 116 is provided midway between the first sensor 112 and the second sensor 114, it is also the case that the second comparison value and the third comparison value should be exactly half the first comparison value. If the calculated comparison values deviate too much from these stated conditions during the operation of the wind power installation, this is an indication that the function of at least one of the sensors is faulty. In particular, a safety margin within which correct functioning of the sensors is ensured can be fixed.

As explained above, a first, second and third thrust force of the rotor 106 can be calculated by

Fₜₕᵣᵤₛₜ₁=V1(H1−H2),

Fₜₕᵣᵤₛₜ₂=V2/(H2−H3),

Fₜₕᵣᵤₛₜ₃=V3/(H1−H3)

where H1 is the height at which the first sensor 112 measures the bending moment, H2 is the height at which the second sensor 114 measures the bending moment and H3 is the height at which the third sensor 116 measures the bending moment.

Allowing for the measuring accuracy, consequently all three calculated thrust forces should be equal. For determining the thrust force 220 of the rotor 106 while allowing for the measuring accuracy of the various sensors, the three thrust forces calculated above may be used in the following formula:

$${F}_{thrust} = {\sum }_{i} {W}_{i} \times {F}_{thrust , i}$$

where i ranges from 1 to 3 in this exemplary embodiment and Wi are weights that replicate the accuracy of the respective measured values. For the weights Wi it is also the case that the sum of all the weights must correspond to one. The weights Wi may for example be dependent on the difference in height, which is entered into the respective calculation of the thrust force. In this case, a greater difference in height is indicative of a more accurate calculation of the thrust force than a smaller difference in height. Furthermore, the weights Wi may comprise information about known measuring accuracies of the sensors used at individual heights. In this way explained above, a particularly accurate determination of the thrust force 220 that acts on the rotor 106 is possible.

This makes it possible to determine the turbulence in the wake of the rotor 106 based on the thrust force 220 determined of the rotor 106. In particular, the thrust coefficient of the rotor 106 can be determined from the measured thrust force 220. It applies here that: the higher the value of the thrust coefficient, the more turbulences are produced in the wake by the rotating rotor 106.

As a result of this direct relationship, the control of the wind power installation 100 based on the thrust force 220 or the thrust force coefficient brings about a direct control of the turbulence that is produced in the wake by the rotor 106.

If the wind power installation 100 is in a wind farm, the wind power installation 100 can be operated in such a way that, based on the determination of the thrust force 220, the turbulences are reduced in such a way that the other wind power installations of the wind farm are not influenced over and above a certain amount. In particular, when there are critical thrust forces, the wind power installation 100 can be operated in a reduced-output mode. This makes it possible to integrate more wind power installations per unit area into the wind farm at the planning stage, without compromising safety and while at the same time increasing the energy yield.

In the embodiment described above, the measuring arrangement comprises three sensors. In another embodiment, the measuring arrangement may however also have two sensors or more than three sensors.

In the embodiment described above, full strain gauge bridges are used as sensors. In another embodiment, however, other sensors that are designed for determining bending moments of the tower of the wind power installation may also be used, for example optical strain sensors.

1. A measuring arrangement of a wind power installation having a tower and an aerodynamic rotor with at least one rotor blade, the measuring arrangement comprising:
a measuring device configured to detect a first bending moment of the tower at a first height and a second bending moment of the tower at a second height, wherein the second height is different from the first height, each of the first and second bending moments being made up of: a natural moment component, a pitching moment component, and a thrust force moment component; and
a processor configured to:
compare the first and second bending moments to determine a first comparison value;
determine a thrust force of the aerodynamic rotor based on the first comparison value determined based on a comparison of the at least first and second bending moments, the first comparison value being independent of the natural moment component and the pitching moment component.

2. The measuring arrangement as claimed in claim 1, wherein the measuring device having a first sensor for detecting the first bending moment of the tower at the first height and a second sensor for detecting the second bending moment of the tower at the second height.

3. The measuring arrangement as claimed in claim 2, wherein the first sensor is arranged directly under a nacelle of the wind power installation, and wherein the second sensor is arranged proximate a foot of the wind power installation.

4. The measuring arrangement as claimed in claim 2, wherein the first and second sensors include strain gauges.

5. The measuring arrangement as claimed in claim 1, wherein the first comparison value is a difference between the first and second bending moments.

6. The measuring arrangement as claimed in claim 5, wherein the thrust force is based on the first comparison value and a difference in height between the first and second heights.

7. The measuring arrangement as claimed in claim 2, wherein the measuring device has at least a third sensor for detecting a third bending moment of the tower at a third height, the third height being between the first and second heights.

8. The measuring arrangement as claimed in claim 7, wherein the processor is configured to determine at least a second and a third comparison value, the second comparison value being formed as a difference between the first and third bending moments the third comparison value being formed as a difference between the third and second bending moments.

9. The measuring arrangement as claimed in claim 8, wherein the processor is configured to determine a first thrust value based on the first comparison value on a difference in height between the first and second heights, a second thrust value based on the second comparison value and a difference in height between the first and third heights, and a third thrust force based on the third comparison value and a difference in height between the third and second heights.

10. The measuring arrangement as claimed in claim 9, wherein the processor is configured to determine the thrust force of the rotor as a mean value of at least two of the first, second and third thrust forces, or the processor is configured to determine the thrust force of the rotor as a weighted combination of the first, second and third thrust forces, weights of the combination being based on a measure of the accuracy of the first, second and third thrust forces.

11. A wind power installation with the measuring arrangement as claimed in claim 1, the wind power installation being configured to be operated in dependence on the determined thrust force.

12. A wind farm for generating electricity, the wind farm having:
at least one wind power installation as claimed in claim 11;
a processor configured to determine a turbulence of at least one wind power installation based on the thrust force of the aerodynamic rotor of the at least one wind power installation; and
a wind farm controller configured to control the at least one wind power installation.

13. A method for determining a thrust force of an aerodynamic rotor of a wind power installation, the method comprising:
detecting a first bending moment of a tower of the wind power installation at a first height and detecting a second bending moment of the tower at a second height, wherein the second height is different from the first height, the first and second bending moments, each including: a natural moment component, a pitching moment component and a thrust force moment component;
comparing the first and second bending moments to determine a first comparison value; and
determining a thrust force based on the first comparison value, the first comparison value being independent of the natural moment component and the pitching moment component.

14. A method for operating a wind power installation, wherein the wind power installation is operated using the thrust force as determined in the method as claimed in claim 13.

15. A method for operating a wind farm, the method comprising:
determining a turbulence of at least one wind power installation based on a thrust force of the rotor of the at least one wind power installation; and
controlling the wind power installations of the wind farm by reducing an output of the at least one wind power installation of the wind farm so that effects of the turbulence of the at least one wind power installation on other wind power installations of the wind farm are reduced.

16. The wind farm as claimed in claim 14, wherein the wind farm controller is configured to cause the at least one wind power installation to reduce its output so that effects of the turbulence of the at least one wind power installation on other wind power installations of the wind farm is reduced.

17. The measuring arrangement as claimed in claim 2 wherein the strain gauges of the first and second sensors are full strain gauge bridges.

18. The measuring arrangement as claimed in claim 6, wherein the thrust force is a ratio of the first comparison value and the difference in height.
